(19) United States
(12) Patent Application Publication
(10) Pub. No.: US 2012/0225225 A1
(43) Pub. Date: Sep. 6, 2012

(54) LOW-MONOMER POLYURETHANE FOAMS

(75) Inventors: Uwe Franken, Dormagen (DE); Michael Krebs, Hilden (DE); Milan Sebestian, Grevenbroich (DE)

(73) Assignee: Henkel AG & Co., KGaA, Duesseldorf (DE)

(21) Appl. No.: 13/426,682

(22) Filed: Mar. 22, 2012

Related U.S. Application Data
(63) Continuation of application No. PCT/EP2010/062435, filed on Aug. 26, 2010.

(30) Foreign Application Priority Data
Sep. 25, 2009 (DE) 10 2009 045 027.0

(51) Int. Cl. C08L 75/08; C08J 9/14; B32B 1/02

(52) U.S. Cl. 428/34.1; 521/154; 521/160; 521/114

(57) ABSTRACT

A crosslinkable foamable composition with low content of monomeric isocyanates comprising a) 10 to 90 wt % of a prepolymer of polyester diols reacted with an excess of diisocyanates and subsequent removal of the excess monomeric diisocyanate, b) 90 to 10 wt % of a component based on polyether polyols which possesses at least one Si(OR)₃ group or at least one NCO group, c) 0.1 to 30 wt % additives, d) and at least one blowing agent, wherein the polyester diols and the polyether diols have a molecular mass (M_{N}) below 5000 g/mol and the mixture of a and b comprises a content of monomeric diisocyanates below 2 wt %.

The invention relates to low-monomer one-component polyurethane foams. Storage stable crosslinkable foam precursors are described that possess high reactivity and when applied result in a good formation of the foam material.

One-component PUR foams are principally used for sealing and insulating joints in the building and do-it-yourself segments. In such applications, the foam product is applied from an aerosol can and is used for example for installing door frames and window frames in buildings. In order to fill the joints between frames and wall, the initial viscosity of the foam has to be sufficiently low in order to ensure an adequate expansion of the foam in the joint. The one-component PUR foam becomes solid as a result of the crosslinking reactions with moisture.

Modern PUR foam compositions normally contain a prepolymer that is formed from an isocyanate component and a polyol component. A high content of monomeric diisocyanates has been required in order to produce a polyurethane foam with adequate strength and low viscosity. The low viscosity enables a good foamability and filling of the joint, as well as a satisfactory metering from the can at normal temperature. Moreover, the monomeric diisocyanate also makes a significant contribution in conventional foaming to the reactivity of the foam. Consequently, one-component foams currently have a significant content of monomeric diisocyanates.

This causes problems during the processing, in that volatile monomeric diisocyanates are released into the working atmosphere in the course of applying (foaming) the contents from the aerosol can. This is in regard to avoiding the adverse effects on health from the monomeric isocyanates. This is why there are restrictions in the use of non-monomer-poor PU foams.

In WO 02/079292 are described adhesive polymers that comprise a prepolymer of an isocyanate component, a polyol and a low viscous component that is unreactive with isocyanates and OH groups. Here, the monomeric diisocyanates should make up less than 2% of the composition. Phosphate acid esters, adipic acid esters or phthalic acid esters are described as the unreactive low viscous component.

In addition, WO 02/090410 is known. This describes a prepolymer that can be obtained by reacting a polyol having a functionality of <3, an isocyanate component having a functionality of 2 to 2.7, as well as a low molecular weight monohydric alcohol. PU foams are intended to be produced from this prepolymer. A number of polyether polyols, polyester polyols, polycaprolactone polyols are listed as the polyol component. However, only polyether polyols and low molecular weight ethylene glycols are described in the practical implementation.

In addition, WO 2005/054324 is known. This describes prepolymer compositions for the production of PU foams, wherein polyisocyanates and polyols can be comprised. The prepolymer is obtained by the reaction of asymmetric polyisocyanates with sterically hindered polyols that contain at least two OH functions. A more detailed description of the polyols reveals that in particular, sterically hindered polyethylene glycols with propylene oxide groups or polypropylene glycols can be used.

It is known that foams can be produced from PU prepolymers based on polyether polyols. They exhibit good properties. If they are adjusted to be low in monomer then, however, the viscosity is so high that these products can often only be used with additional diluents, such as plasticizers or solvents. Plasticizers or solvents are detrimental to health during the processing. In addition, they can diffuse out of the crosslinked foam, thereby negatively affecting the adhesion to the substrates.

Polyester polyol prepolymers can also be used in foam materials. It is likewise the case that the precursor materials have a high viscosity. This effect is also exacerbated by low-monomer prepolymers. Consequently, they are not used as low-monomer components in foams. Moreover, it has been shown that PU foams with only low fractions of isocyanate groups or of monomeric isocyanates do not exhibit an adequate mechanical strength as crosslinked foam.

The disadvantages of the individual prepolymers, together with the reduction in the isocyanate monomers required by occupational health and safety regulations, lead to prepolymers that cannot be processed or only processed together with additional low molecular weight solvents. Accordingly, there results the object of providing low-monomer PU prepolymers that can crosslink through NCO groups, that comprise neither solvent nor plasticizer, but that exhibit a sufficiently low viscosity to be able to be used as a foam material in reactive foaming. Furthermore, the resulting crosslinked polymer foams should exhibit mechanical properties that can be achieved with the previously known foam materials, which comprise high contents of monomeric isocyanates.

The object is achieved by a crosslinkable foamable composition with a low content of monomeric isocyanates comprising a) 10-90 wt % of a prepolymer of polyester diols reacted with an excess of diisocyanates and subsequent removal of the excess monomeric diisocyanates, b) 90 to 10 wt % of a component based on polyether polyols which possesses at least one Si(OR)₃ group or at least one NCO group, c) 0.1 to 30 wt % additives, and d) at least one blowing agent, wherein the polyester prepolymers and the polyether prepolymers have a molecular mass (M_{N}) below 5000 g/mol and the mixture of a and b comprises a content of monomeric diisocyanates below 2 wt %.

Prepolymers based on polyesters (a) are a necessary ingredient of the composition according to the invention. They can be produced by the reaction of polyester polyols with diisocyanates. Suitable polyester polyols are reaction products of polyhydric, preferably dihydric alcohols, optionally together with minor amounts of trihydric alcohols, and polyfunctional, preferably difunctional and/or trifunctional carboxylic acids. Instead of free polycarboxylic acids, the corresponding polycarboxylic acid anhydrides or corresponding polycarboxylic acid esters with alcohols having preferably 1 to 3 carbon atoms can also be employed. For the production of these types of polyester polyols, suitable exemplary diols are ethylene glycol, 1,2- or 1,3-propane diol, 1,2- or 1,4-butane diol, pentane diol, the isomeric hexane diols, octane diol, 1,4-hydroxymethylcyclohexane, 2-methyl-1,3-propane diol, 1,2,4-butane triol, triethylene glycol, tetraethylene glycol, polyethylene glycol, dipropylene glycol, polypropylene glycol, dibutylene glycol or polybutylene glycol. Aromatic diols can also be used.

The added polycarboxylic acids can be aliphatic, cycloaliphatic, aromatic or heterocyclic or both. The can be optionally substituted, for example by alkyl groups, alkenyl groups, ether groups or halides. Succinic acid, adipic acid, suberic acid, azelaic acid, sebacic acid, phthalic acid, isophthalic acid, terephthalic acid, trimellitic acid, phthalic anhydride, tetrahydrophthalic anhydride, hexahydrophthalic anhydride, glutaric anhydride, maleic acid, maleic anhydride, fumaric acid, dimer fatty acids or mixtures of two or more thereof are suitable exemplary polycarboxylic acids. Citric acid or trimellitic acid are exemplary suitable tricarboxylic acids that can optionally be comprised pro rata. All the cited acids can be added individually or as mixtures of two or more.

Such OH-functional polyesters are known to the person skilled in the art and are commercially available. Polyester polyols possessing three or especially two terminal OH groups are particularly suitable.

However, polyester polyols of oleochemical origin may also be used. Such types of polyester polyols can be manufactured by the total ring opening of epoxidized triglycerides of a fat mixture comprising at least partially olefinically unsaturated fatty acids with one or more alcohols having 1 to 12 carbon atoms and subsequently partially transesterifying the triglyceride derivatives to alkyl ester polyols having 1 to 12 carbon atoms in the alkyl group.

Polyester polyols preferably have a molecular mass of ca. 200 to 5000 g/mol, especially below 2000 g/mol (number average molecular mass, M_{N}, measured by GPC). In particular, polyester polyols that comprise aromatic structures, are also suitable.

The known aliphatic or aromatic diisocyanates are suitable isocyanates for the production of the NCO-containing prepolymers. They have a molecular mass of less than 500 g/mol. Exemplary suitable diisocyanates that can be used are ethylene diisocyanate, 1,4-tetramethylene diisocyanate, 1,4-tetramethoxybutane diisocyanate, 1,6-hexamethylendiisocyanat (HDI), cyclobutane-1,3-diisocyanate, cyclohexane-1,3- and -1,4-diisocyanate, bis(2-isocyanato-ethyl) fumarate, 1-isocyanato-3,3,5-trimethyl-5-isocyanatomethylcyclohexane (isophorone diisocyanate, IPDI), 2,4- and 2,6-hexahydrotoluylene diisocyanate, hexahydro-1,3- or -1,4-phenylene diisocyanate, benzidine diisocyanate, naphthalene-1,5-diisocyanate, 1,6-diisocyanato-2,2,4-trimethylhexane, 1,6-diisocyanato-2,4,4-trimethylhexane, xylylene diisocyanate (XDI), tetramethylxylylene diisocyanate (TMXDI), 1,3- and 1,4-phenylene diisocyanate, 2,4- or 2,6-toluylene diisocyanate (TDI) or isomeric mixtures of the TDI, 2,4′-diphenylmethane diisocyanate, 2,2′-diphenylmethane diisocyanate or 4,4′-diphenylmethane diisocyanate (MDI) as well as their isomeric mixtures. Furthermore, partially or completely hydrogenated cycloalkyl derivatives of the MDIs, come into consideration, for example completely hydrogenated MDI (H12-MDI), alkyl-substituted diphenylmethane diisocyanates, for example mono, di, tri or tetraalkyldiphenylmethane diisocyanate as well as their partially or completely hydrogenated cycloalkyl derivatives. Aromatic diisocyanates should be preferably used, MDI being quite particularly preferred.

Another embodiment uses asymmetric isocyanates that possess NCO groups with a different reactivity towards diols. Exemplary suitable cycloaliphatic asymmetric diisocyanates are 1-isocyanato methyl-3-iso-cyanato-1,5,5-trimethyl-cyclohexane (isophorone diisocyanate, IPDI), 1-methyl-2,4-diisocyanato-cyclohexane, 1,4-diisocyanato-2,2,6-trimethylcyclohexane (TMCDI), or hydrogenated products of the abovementioned aromatic diisocyanates, for example hydrogenated MDI in isomeric pure form, preferably hydrogenated 2,4′-MDI. Exemplary preferred suitable aromatic asymmetric diisocyanates are 2,4- or 2,6-toluylene diisocyanate (TDI), either in isomeric pure form or as the mixture of a plurality of isomers, naphthalene-1,5-diisocyanate (NDI), diphenylmethane-2,4′-diisocyanate (MDI) as well as mixtures of the 4,4′-diphenylmethane diisocyanate with the 2,4′-MDI isomers.

One embodiment reacts the polyols with an excess of a diisocyanate. Unreacted fractions of the isocyanate are then distilled off under vacuum again as the monomer. Another embodiment uses an asymmetric isocyanate, thus a distillation can be avoided with a suitable reaction control.

The reaction of the monomeric diisocyanates with the polyols occurs at a temperature between 20° C. and 100° C., preferably between 25 and 80° C. and especially preferably between 40 and 75° C. The quantities are selected such that an NCO-terminated prepolymer is obtained. The reaction control ensures that low-monomer products are obtained. The reaction of the polyester polyols can be effected according to known processes. Low contents of monomeric isocyanates should be obtained, for example below 2 wt %, especially below 1 wt %. The selected ratio of diol and diisocyanate ensures that no significant molecular weight increase of the prepolymer is obtained.

NCO group-containing prepolymers based on polyethers (b) are another ingredient for a composition according to the invention. They are produced for example by reacting polyether polyols with a stoichiometric excess of isocyanates.

Exemplary suitable polyether polyols are the reaction products of low molecular polyhydric alcohols with alkylene oxides. The alkylene oxides preferably possess 2 to 4 carbon atoms. The reaction products of ethylene oxide, propylene oxide, butylene oxide or mixtures thereof with aliphatic diols, such as ethylene glycol, 1,2-propane diol, 1,3-propane diol, the isomers of butane diols, hexane diols, 2,2-dimethyl-1,3-propane diol, 2-methylpropane diol, 1,6-hexane diol, 2,4,4-trimethylhexane1,6-diol, 2,2,4-trimethylhexane-1,6-diol, 1,4-cyclohexane dimethanol, or of aromatic diols, such as 4,4′-dihydroxydiphenylpropane Bisphenol A, Bisphenol F, pyrocatechol, resorcinol, hydroquinone or mixtures of two or more thereof are exemplary suitable. Furthermore, the reaction products of polyhydric alcohols, such as glycerin, trimethylolethane or trimethylolpropane, pentaerythritol or sugar alcohols with the alkylene oxides are also suitable. In the context of the invention, further suitable polyols are obtained by polymerizing tetrahydrofuran (poly-THF).

The polyether polyols are produced in a manner known to the person skilled in the art and are commercially available. According to the invention, low molecular weight polyethers should be chosen. Exemplary particularly suitable polyether polyols have a molecular mass of 200 to 5000 g/mol, especially up to 3000 g/mol, advantageously up to 1500 g/mol. Diols are particularly suitable, such as homopolymers of polyethylene glycol, propylene glycol, block or statistical copolymers of ethylene glycol and propylene glycol, in particular those that comprise secondary hydroxyl groups.

As already described above for the prepolymers (a), these polyether polyols can be reacted with known isocyanates to afford NCO-containing prepolymers.

These prepolymers should be monomer-poor. This can be achieved by means of reaction control; another approach separates free monomeric isocyanates by distillation. The polyether prepolymers should comprise at least one NCO group in the chains, preferably two or three NCO groups. Average functionalities of for example 1.8 to 3.3 are also possible by mixing prepolymers.

In the monomer-poor state, the polyether prepolymers have a viscosity from 3000 to 50 000 mPas at 50° C. (measured by Brookfield, EN ISO 2555). The monomer content should be below 2 wt %, preferably below 1%, particularly below 0.2%. Prepolymers that have been produced with only a low molecular weight structure are quite particularly preferably used. Thus, the polydispersity D (measured as M_{w}/M_{N}) should be less than 3.0, in particular below 2.5, preferably less than 2.0.

A different embodiment of the invention uses polyether prepolymers (b) that possess at least one alkoxysilane group, preferably two or three alkoxy groups that in particular are located in a terminal position of the polymer chain. The polymer backbone can consist of the abovementioned polyether building blocks, with alkoxysilane groups reacted on the chain. Silane-terminated polyethers of this type can be produced for example by reacting NCO-terminated polyethers with those alkoxysilanes that additionally possess another group that reacts with NCO, for example secondary aminosilanes or hydroxysilanes. Another production approach produces such polymers by reacting polyethers terminated with double bonds that are subsequently subjected to hydrosilation. Polyethers of this type with a molecular mass of less than 10 000 g/mol are known to the person skilled in the art and are commercially available. These polyether polymers should not have any free OH groups that can react with the NCO groups of the other prepolymers. Particularly suitable prepolymers of this type have a molecular mass of less than 5000 g/mol, preferably 500 to 3000 g/mol. The polydispersity should be low, for example less than 2.0, especially below 1.7.

The composition according to the invention must comprise at least one prepolymer based on polyesters as the foam precursor. The amount of polyester prepolymer should comprise 10 to 90 wt %, based on the total non-volatile fractions, without blowing agent, in particular 20 to 60 wt %. In addition, the composition according to the invention must comprise a polyether prepolymer in the amount of 90 to 10 wt %, in particular between 40 and 80 wt %. In this regard, the prepolymers may be produced separately and mixed or in the case of NCO-crosslinking prepolymers, synthesized as a mixture. Here, polyether polyols or polyester polyols of differing molecular masses can be used. If too high a quantity of the polyether polyols is chosen, then the flame resistance of the finished foamed and crosslinked product is worse. If too low an amount of the polyether polyols is chosen, then a sufficiently low viscosity of the foam precursor is unachievable. The viscosity of the mixture of the components a and b should be between 2000 and 150 000 mPas measured at 50° C., particularly 10 000 to 100 000. In this regard, one embodiment can have polyester prepolymers together with NCO-polyether prepolymers, another embodiment uses at least one silane-functionalized polyether as the polyether prepolymer. The mixture of the prepolymers a and b should have a content of monomeric diisocyanates of less than 2%, preferably less than 1%, in particular less than 0.2%.

In addition, the composition according to the invention can also comprise additives that are known for foam production as the foam precursor. These can be for example plasticizers, stabilizers, adhesion promoters, catalysts, flame retardants, biocides, cell openers and similar adjuvants. In such a case it is advantageous to maintain as low as possible the fraction of ingredients that are not reacted in the polymer, such as plasticizers or solvents.

Up to 40 wt % of plasticizers can be comprised in the foam precursor, in particular even no plasticizer or between 0.5 and 20 wt %, based on the total composition. Plasticizers with polar groups are preferred. Suitable plasticizers are known to the person skilled in the art and are commercially available.

In the context of this invention, stabilizers are understood to mean antioxidants, UV-stabilizers, hydrolysis stabilizers or foam stabilizers. Examples of these are the commercial sterically hindered phenols and/or thioethers and/or substituted benzotriazoles and/or amines of the HALS type (Hindered Amine Light Stabilizer). In the context of the present invention, it is particularly preferred if a UV stabilizer is employed that carries a silane group and becomes attached to the end product during crosslinking or curing. Furthermore, benzotriazoles, benzophenones, benzoates, cyanoacrylates, acrylates or sterically hindered phenols can also be added. Exemplary foam stabilizers are polyether siloxanes, such as copolymers of ethylene oxide and propylene oxide bonded to a polydimethylsiloxane group, polysiloxane-polyoxyalkylene copolymers branched through allophanate groups, other organopolysiloxanes, such as dimethylpolysiloxanes; oxyethylated alkylphenols, oxyethylated fatty alcohols, and/or paraffin oils. Furthermore, for improving the emulsifying action, the cell structure and/or stabilization, oligomeric polyacrylates containing polyoxyalkylene and fluoroalkane groups as the side chain groups are suitable. The inventively foamable mixtures can comprise foam stabilizers e.g. in amounts ranging between 0.1 and 5 wt %, based on the mixture of the non-volatile fractions.

If needed, organofunctional silanes, such as hydroxy-functional, (meth)acryloxy-functional, mercapto-functional, amino-functional or epoxy-functional silanes can preferably be used as adhesion promoters. The amounts can range between 0 and 20 wt %, preferably between 0 and 5 wt %, based on the mixture.

Catalysts can also be comprised. All known compounds that can catalyze the isocyanate reactions can be added as the catalysts. Examples of these are titanates such as tetrabutyltitanate and tetrapropyltitanate, tin carboxylates such as dibutyltin dilaurate (DBTL), dibutyltin diacetate, tin octoate; tin oxides such as dibutyltin oxide, and dioctyltin oxide; organoaluminum compounds such as aluminum trisacetylacetonate, aluminum trisethylacetoacetate; chelate compounds such as titanium tetraacetylacetonate; amine compounds such as triethylenediamine, guanidine, diphenylguanidine, 2,4,6-tris(dimethylaminomethyl)phenol, morpholine, N-methylmorpholine, 2-ethyl-4-methylimidazole, and 1,8-diazabicyclo-(5,4,0)-undec-7-ene (DBU), 1,4-diazabicyclo[2,2,2]octane, N,N-dimethylpiperazine, 1,8-diazabicyclo[5.4.0]undec-7-ene, dimorpholinodimethyl ether, dimorpholinodiethyl ether (DMDEE) or their mixtures. The catalyst, preferably mixtures of a plurality of catalysts, is added in an amount of 0.01 to about 5 wt %, based on the total weight of the preparation.

In another embodiment, a foamable mixture according to the invention comprises at least one liquid flame retardant. The flame retardant can be selected from the group of the halogenated (especially brominated) ethers of the “Ixol” type from the Solvay company, 3,4,5,6-tetrabromo-, 2-(2-hydroxyethoxy)ethyl-2-hydroxypropyl ester), organic phosphates, in particular diethyl ethanephosphonate, triethyl phosphate, dimethyl propyl phosphonate, diphenyl cresyl phosphate, as well as chlorinated phosphates, in particular tris-(2-chloroethyl)phosphate, tris-(2-chloroisopropyl)phosphate, tris(1,3-dichloroisopropyl)phosphate, tris(2,3-dibromopropyl)phosphate and tetrakis(2-chloroethyl)ethylene diphosphate or their mixtures. The mixture preferably comprises the flame retardant in an amount of 1 to 50 wt %, particularly preferably from 5 to 20 wt %, based on the total weight of the mixture. From the abovementioned flame retardants, it is advantageous to select those that do not possess hydroxyl groups, as these groups reduce the content of reactive NCO groups.

A foamable composition according to the invention comprises, in addition to the mixture of the prepolymer, at least one blowing agent. A large number of highly volatile hydrocarbons can, in principle, be used as the blowing agent. Particularly preferred blowing agents are selected from hydrocarbons and/or fluorinated hydrocarbons each with 1-5 carbon atoms and/or dimethyl ether (DME) as well as their mixtures, for example DME/propane/isobutane/n-butane. The blowing agents are added in amounts of 5 to 40 wt %, preferably 10 to 30 wt %, based on the total foamable mixture.

A preferred embodiment of the foam precursor according to the invention can comprise 10 to 90 wt %, preferably 30 to 60 wt % of a polyester prepolymer (a), 90 to 10 wt %, especially 70 to 40 wt % polyoxyalkylene prepolymer containing at least one isocyanate group (b1) or containing at least one silane group (b2), 0.5 to 30 wt % auxiliaries and additives, especially catalysts, flame retardants and/or stabilizers. The total of these ingredients should amount to 100 wt %. The mixture according to the invention also additionally comprises inert blowing agents.

One embodiment uses polymers that comprise di or trialkoxysilyl groups that permit curing and good final strengths. A further advantage of such polymers that comprise alkoxy groups is that they lower the viscosity and form a network, such that no migration of unreacted polymers is observed at a later time. As the crosslinking proceeds more slowly than the crosslinking of the NCO groups, the network structure is not destroyed.

The other embodiment works with mixtures of NCO-crosslinking polyether prepolymers and polyester prepolymers. These mixtures react equally. It has been shown that the mixtures of such polymers also have a low viscosity. At the same time there is a high reactivity, thus the content of monomeric isocyanates is kept low.

A further subject matter of the present invention is a disposable pressure container comprising a foamable mixture according to the invention or a foamable mixture, produced according to a process according to the invention. The disposable pressure container (aerosol can) therefore comprises at least one polyester prepolymer and one polyether prepolymer, and at least one blowing agent. In order to enable easy processing of the mixture—especially the filling of the container—the viscosity of the mixture of the non-volatile ingredients ranges inventively from 2000 to 150 000 mPas, preferably 5000 to 80 000 mPas (measured at 50° C.).

The foamable mixtures according to the invention cure after being deployed out of the aerosol can by reacting with the ambient humidity to form fine celled foams, such that the foamable mixtures are suitable for sealing, insulating and/or installing, e.g. joints, roof surfaces, windows and doors or for filling up cavities.

Accordingly, a further subject matter of the present invention is also the use of a foamable mixture according to the invention or a foamable mixture, produced according to a process according to the invention for sealing, insulating and/or installing joints, roof surfaces, windows and doors or for filling up cavities.

Another subject matter of the invention is a process for producing foamable, crosslinkable compositions. According to this process, a prepolymer of at least one polyester diol is produced with a molar excess of an aromatic diisocyanate. This excess can include a ratio of 1:2 to 1:10. After the reaction, the unreacted monomeric diisocyanate is distilled off to a content of less than 2 wt % based on the prepolymer, preferably below 1%, especially less than 0.2%. In this regard, the distilled diisocyanate can be used again in the synthesis of the prepolymer. Particularly suitable isocyanates for the process are aromatic isocyanates, such as 4,4-diphenylmethane diisocyanate or mixtures of the MDI isomers; another embodiment uses asymmetric aromatic isocyanates such as TDI, 2,4 MDI. In this case the excess of diisocyanate can be chosen to be lower, for example ca. 1:2.

An additional water-crosslinkable prepolymer can be added to this prepolymer. This can be an NCO-terminated prepolymer based on polyethers. They can be produced as already described above, with an excess of monomeric preferably aromatic diisocyanates, wherein after the reaction the residual monomeric diisocyanates are distilled off down to a content of less than 2%, especially below 0.2%. This can be effected in a separate synthetic reaction, although it is also possible to produce this PU prepolymer together with the abovementioned polyester prepolymer.

Another embodiment of the process works with polyether polymers which contain at least one silane group containing hydrolysable groups. As hydrolysable groups, those of the type Si(OR)₃ with —OR selected from methoxy, ethoxy, propoxy, butoxy are used. In particular, such prepolymers can also comprise two silane groups. These are produced separately to the NCO prepolymers.

According to the process according to the invention, a mixture of the polyester prepolymer and the polyether polymer is produced under anhydrous conditions. The additives that can be comprised in a composition according to the invention can optionally be added thereto. At least one propellant gas is additionally added to this mixture. This can be effected by mixing the prepolymer/additive mixture with propellant gas, this mixture being subsequently filled into the appropriate disposable pressure container. It is likewise possible to put the various prepolymers and additives individually into the appropriate container and then add the propellant gas. The components are blended together using known techniques. The mixing of the components can also be supported by heating, such that the processing processes proceed faster. Mixtures, filled up in disposable pressure containers are obtained. As long as one works under anhydrous conditions, the mixtures are storage stable for a period of at least 6 months.

Compositions that correspond to the above described crosslinkable foamable compositions according to the invention are particularly suitable for use in a process according to the invention.

The foamable compositions according to the invention are particularly applicable for use as a one-component canned foam. They are usually called in-situ foam, i.e. they are filled into aerosol cans for the production and storage and transport and extracted and foamed directly prior to application. The composition according to the invention enables isocyanate-reactive polyurethane foams to be produced that have a low monomer content. They have a composition that has an adequate viscosity to be foamable with the known blowing agents. The foam precursors according to the invention cure with the ambient moisture in the air and afford fine-celled, mechanically stable foams. These foams can also be designed to be flame retardant through particular developments of the composition.

Due to the low content of free isocyanates, the requirements with regards to work safety and protection of health are fulfilled. The technical application properties of the foamed materials are equally as good when compared with those of the known prior art.

The foamable mixtures according to the invention cure after being deployed out of the aerosol can by reacting with the ambient humidity to form fine celled foams, such that the foamable mixtures are suitable for sealing, insulating and/or installing, e.g. joints, roof surfaces, windows and doors or for filling up cavities. A further advantage of the composition according to the invention is the improved fire performance of the cured foam.

### EXAMPLES

### Quantities in Parts

| Exp. | Prepo. | Prepo. | Prepo. | Exp. | Prepo. | Prepo. | Prepo. | Prepo. |
|---|---|---|---|---|---|---|---|---|
| no | 1 | 2 | 3 | no | 1 | 2 | 4 | 5 |
| 1 | 100 | | 0 | 11 | | 100 | 0 | |
| 2 | 80 | | 20 | 12 | | 80 | 20 | |
| 3 | 50 | | 50 | 13 | | 50 | 50 | |
| 4 | 20 | | 80 | 14 | | 20 | 80 | |
| 5 | 0 | | 100 | 15 | | 0 | 100 | |
| 6 | | 100 | 0 | 16 | 100 | | 0 | |
| 7 | | 80 | 20 | 17 | 80 | | 20 | |
| 8 | | 50 | 50 | 18 | 50 | | 50 | |
| 9 | | 20 | 80 | 19 | 20 | | 80 | |
| 10 | | 0 | 100 | 20 | 0 | | 100 | |
| | | | | 21 | 100 | | | 0 |
| | | | | 22 | 80 | | | 20 |
| | | | | 23 | 50 | | | 50 |
| | | | | 24 | 20 | | | 80 |
| | | | | 25 | 0 | | | 100 |

### Result

| Viscosity [mPas] | 30° C. | 50° C. | 80° C. |
|---|---|---|---|
| Example 1 | unmeasurable | 16100 | 9200 |
| 2 | | 105000 | 6350 |
| 3 | | 57000 | 2850 |
| 4 | | 53500 | 2450 |
| 5 | | 44000 | 1850 |
| 6 | unmeasurable | 450000 | 10200 |
| 7 | | 257000 | 6800 |
| 8 | | 105000 | 3500 |
| 9 | | 81000 | 2700 |
| 10 | | 44000 | 1800 |
| 11 | unmeasurable | 450000 | 10500 |
| 12 | | 202000 | 5600 |
| 13 | | 57000 | 3000 |
| 14 | | 20000 | 1200 |
| 15 | | 8000 | 800 |
| 16 | | 161000 | 9200 |
| 17 | unmeasurable | 116000 | 6800 |
| 18 | 595000 | 19600 | 1700 |
| 19 | 210000 | 15200 | 1300 |
| 20 | | 8000 | 800 |
| 21 | unmeasurable | 16100 | 9200 |
| 22 | | 2100 | 1050 |
| 23 | 2200 | 1100 | 450 |
| 24 | 540 | 150 | 60 |
| 25 | 200 | 20 | 10 |

| | |
|---|---|
| Polyester A | consisting of adipic acid/isophthalic acid/ |
| | propylene glycol/diethylene glycol Viscosity |
| | at 25° C.: 1350 mPa*s OHN: 135 |
| Polyester B | consisting of adipic acid/phthalic acid/1,2- |
| | propane diol/diethylene glycol Viscosity at |
| | 25° C.: 3000 mPa*s OHN: 190 |
| PPG 400 | polypropylene glycol 400 (Lupranol 400/BASF) |
| | OHN: 256 |
| PPG 750 | mixture of polypropylene glycol 400 and 1000 |
| | (Voranol 1010L/Dow) OHN: 145 |
| MDI | 4,4′-diphenylmethane diisocyanate (Desmodur |
| | 44 M/Bayer) |
| MIS | mixture of 2,4′ and 4,4′-diphenylmethane |
| | diisocyanate (Desmodur 2460 MI) |

A prepolymer was produced from the diols with an excess of a diisocyanate (mole ratio 6:1). At the end of the reaction the prepolymer was freed of unreacted monomeric diisocyanate by means of a thin layer evaporator under vacuum. The residual monomer content of all samples was less than 1 wt % of monomeric MDI.

Prepolymer 1: polyester A+4,4′-MDI

Prepolymer 2: polyester A+4,4′-MDI

Prepolymer 3: PPG 400+MIS

Prepolymer 4: PPG 750+MIS

Prepolymer 5: silyl-terminated polyether(polypropylene glycol-bis-[3-(dimethoxymethylsilyl)-propyl]ether

It was shown that the viscosity of the prepolymer does not increase linearly with the increasing content of polyester prepolymer; the viscosity behavior was synergistically influenced to lower values by the addition of polyether prepolymers.

In examples 3, 8, 13, 18, foamable mixtures were produced by adding a mixture of propane/dimethyl ether (1:1), 30 wt % to the whole mixture. These mixtures were filled into a disposable pressure container. The mixtures were homogenized by shaking, and stored for one day. It was found that the mixtures were easily ejected as a foam. They crosslinked quickly.

Analogous mixtures were produced with 30% of the blowing agent mixture from the experiments 1, 6, 11, 16. The pressure containers had to be filled at higher temperature. After cooling and storage for 24 hours it was observed that only a poor delivery of foam from the pressure vessel occurred. The amount was low. Foaming did not produce homogenous foam. The foam that came out of the can was not uniform; probably the mixture was not homogeneous in the can. These mixtures could not be used as foamable compositions.

Additional experiments were carried out with additives. They did not significantly influence the foamability.

Example 3+0.05% DMEE as the catalyst

Example 8+0.4% paraffin oil

Example 13+0.2% UV-stabilizer

Example 18+5% trichloroisopropyl phosphate

1. A crosslinkable foamable composition with low content of monomeric isocyanates comprising
a) 10 to 90 wt % of a prepolymer of polyester diols reacted with an excess of diisocyanates and subsequent removal of the excess monomeric diisocyanate,
b) 90 to 10 wt % of a component based on polyether polyols which possesses at least one Si(OR)₃ group or at least one NCO group,
c) 0.1 to 30 wt % additives,
d) at least one blowing agent,
wherein the polyester diols and the polyether diols have a molecular mass (M_{N}) below 5000 g/mol and the mixture of a and b comprises a content of monomeric diisocyanates below 2 wt %.

2. The composition according to claim 1, wherein the NCO monomer content of the composition is below 1% and the NCO content of the composition is between 2 and 15%.

3. The composition according to claim 1, wherein the polyester diols of the component (a) are polyester diols with a molecular mass of less than 2000 g/mol and is comprised in an amount of 20 to 60 wt %.

4. The composition according to claim 1, wherein component (b) is comprised in an amount of 40 to 80 wt ° A) and is manufactured based on linear polyether diols with a molecular mass of less than 1500 g/mol and comprises two aromatic isocyanate groups.

5. The composition according to claim 1, wherein the component (b) possesses two terminal Si(OR)₃ groups with —OR selected from methanol, ethanol or propanol, and (b) is comprised in an amount of up to 40 wt %.

6. The composition according to claim 1, comprising foam stabilizers, catalysts, dyes or pigments, cell openers and/or UV-stabilizers as the additives.

7. The composition according to claim 1, comprising DME or mixtures of DME with C₁ to C₅ alkanes as the blowing agent.

8. The composition according to claim 1 wherein the viscosity of the mixture of the reactive components a and b is between 30 000 and 150 000 mPas at 50° C.

9. A disposable pressure vessel comprising a composition according to claim 1.

10. A process for manufacturing a foamable crosslinkable composition according to claim 1, wherein the prepolymer (a) of at least one polyester diol is manufactured with an excess of aromatic diisocyanates in the NCO/OH ratio of 2:1 to 10:1, the unreacted monomeric diisocyanate is distilled off, and to this mixture are added a component (b) comprising at least one Si(OR)₃ group or at least one NCO group and component (d) and/or (c), wherein the mixture of (a) and (b) has a viscosity of 30 000 to 150 000 mPas at 50° C. and has a content of monomeric diisocyanates of less than 2%.

11. The process for manufacturing a foamable crosslinkable composition according to claim 10, wherein the prepolymer of at least one polyester diol mixed with at least one polyether diol is manufactured with an excess of aromatic diisocyanates in the NCO/OH ratio of 2:1 to 10:1, the unreacted monomeric diisocyanate is distilled off to less than 1%, and the mixture together with additives and blowing agent is filled into a disposable pressure container and homogenized.

12. The process according to claim 10, wherein the components (a) and/or (b) mixed with at least one blowing agent are introduced into a can.

13. The process according to claim 10, wherein the NCO content of the composition is increased by adding non-volatile oligomeric/polymeric isocyanates.

14. A foamed composition prepared from the crosslinkable foamable composition of claim 1.

15. A crosslinked foam comprising reaction products of the crosslinkable foamable composition of claim 1.
